(19) United States
(12) Patent Application Publication
(10) Pub. No.: US 2023/0089650 A1
(43) Pub. Date: Mar. 23, 2023

(54) ELECTRONIC DEVICE FOR RECOGNIZING EACH OF PLURALITY OF DISPLAY MODULES AND METHOD FOR RECOGNIZING MULTI-DISPLAY

(71) Applicant: SAMSUNG ELECTRONICS CO., LTD., Suwon-si (KR)

(72) Inventors: Chunwoo PARK, Suwon-si (KR); Hyeonseung BAE, Suwon-si (KR); Jeongjun OH, Suwon-si (KR)

(73) Assignee: SAMSUNG ELECTRONICS CO., LTD., Suwon-si (KR)

(21) Appl. No.: 17/993,523

(22) Filed: Nov. 23, 2022

Related U.S. Application Data
(63) Continuation of application No. PCT/KR2021/001762, filed on Feb. 10, 2021.

(30) Foreign Application Priority Data
Jun. 10, 2020 (KR) 10-2020-0070467

(51) Int. Cl. G06F 3/14; H04N 23/61; G09G 3/20

(52) U.S. Cl. CPC G06F 3/1446; H04N 23/61; G09G 3/2092; G09G 3/20; G09G 2356/00; G09G 2300/026

(57) ABSTRACT

An electronic device comprises: a communication unit; a camera; and a processor that controls, via the communication unit, a display wall comprising a plurality of display modules. The processor configured to control the display wall so that the plurality of display modules sequentially display a preset image; obtain a plurality of images by controlling the camera to capture the plurality of images of the display wall while each display module among the plurality of display modules displays the preset image; and identifies a location and a shape of each display module among the plurality of display modules of the display wall, based on the plurality of images.

### CROSS-REFERENCE TO RELATED APPLICATION

This application is a continuation application, under 35 U.S.C. § 111(a), of international application No. PCT/KR2021/001762, filed on Feb. 10, 2021, which claims priority under 35 U. S. C. § 119 to Korean Patent Application No. 10-2020-0070467, filed on Jun. 10, 2020, the disclosures of which are incorporated herein by reference in their entirety.

### BACKGROUND

### Field

This disclosure relates to an electronic device and a method for recognizing a multi-display module modules included in a display wall. More particularly, this disclosure relates to an electronic device and a method for recognizing a multi-display for identifying the location and shape of each of the plurality of display modules by capturing a plurality of display modules that sequentially display a preset image.

### Description of Related Art

In order to calibrate a screen of a multi-display device, a process of analyzing/calibrating the image quality of each display module included in the multi-display device is required.

However, for this purpose, the identification number of each display module and the location in the multi-display device of each display module should be preset/input.

In the related-art, a user had to input the identification number and location of each display module included in the multi-display device through a remote control, a set-top box, or other control device, which makes a user inconvenient.

In order to analyze the image quality of the multi-display device, a user or technician may have to manually capture the display modules included in the multi-display device individually or entirely.

### SUMMARY

An electronic device according to an embodiment includes a communication unit; a camera; and a processor configured to control, through the communication unit, a display wall comprising a plurality of display modules, and the processor may control the display wall so that the plurality of display modules sequentially display a preset image, obtain a plurality of images by controlling the camera to capture the plurality of images of the display wall while each display module among the plurality of display modules displays the preset image, and identify a location and a shape of each display module among the plurality of display modules of the display wall, based on the plurality of images.

The preset image may identify a screen edge of each display module among the plurality of display modules, and the processor may identify the location of each display module among the plurality of display modules based on a location of the preset image included in each image among the plurality of images, and identify the shape of each display module among the plurality of display modules based on a shape of the preset image included in each image the plurality of images.

The preset image may be a pattern image or a color image that fills an entire screen of each display module among the plurality of display modules, and the processor may control the display wall so that each display module among the plurality of display modules displays the same preset image.

The electronic device may further include a memory. The processor may, based on the identified location and shape of each display module, generate one map image in which the plurality of display modules are divided in the display wall and control the memory to store the map image.

The processor may provide the map image stored in the memory to the display wall through the communication unit.

The processor may obtain a captured image of the display wall captured through the camera while at least one of the plurality of display modules is displaying a test image, identify a region that requires screen correction in the captured image, identify a display module corresponding to a location of the identified region in the map image, and perform the screen correction for the identified display module.

The processor may divide, based on the map image, an image to be displayed on the display wall into a plurality of sub-images corresponding to each display module among the plurality of display modules, and transmit the plurality of sub-images to the display wall through the communication unit.

The processor may sequentially transmit a control signal corresponding to each identification number among a plurality of identification numbers distinguishing the plurality of display modules to a control device by being connected to the control device of the display wall through the communication unit. The processor may obtain the plurality of images by controlling the camera to capture the display wall while each display module among the plurality of display modules displays the preset image according to control of the control device that receives the control signal, and identify the location and the shape of each display module corresponding to each of the plurality of identification numbers based on the plurality of images.

A method for recognizing a multi-display of an electronic device includes controlling a display wall so that the plurality of display modules sequentially display a preset image through connection with the display wall including a plurality of display modules; obtaining a plurality of images by capturing the plurality of images of the display wall while each display module among the plurality of display modules displays the preset image; and identifying a location and a shape of each display module among the plurality of display modules of the display wall, based on the plurality of images.

The controlling the display wall may include controlling the display wall so that the plurality of display modules display the preset image which identifies a screen edge of each of the plurality of display modules. The identifying the location and shape of each display module may include identifying the location of each display module among the plurality of display modules based on a location of the preset image included in each image among the plurality of captured images, and identifying the shape of each display module among the plurality of display modules based on a shape of the preset image included in each image among the plurality of captured images.

The preset image may be a pattern image or a color image that fills an entire screen of each display module among the plurality of display modules, and the controlling the display wall may include controlling the display wall so that each display module among the plurality of display modules displays the preset image.

The method may further include, based on the identified location and shape of each display module, generating one map image in which the plurality of display modules are divided in the display wall.

The method may further include providing the map image to the display wall.

The method may include obtaining a captured image of the display wall through the camera while at least one of the plurality of display modules is displaying a test image; identifying a region that requires screen correction in the captured image; identifying a display module corresponding to a location of the identified region in the map image; and performing the screen correction for the identified display module.

The method may further include dividing, based on the map image, an image to be displayed on the display wall into a plurality of sub-images corresponding to each display module among the plurality of display modules; and transmitting the plurality of sub-images to the display wall.

The controlling the display wall may include sequentially transmitting a control signal corresponding to each identification number among a plurality of identification numbers distinguishing the plurality of display modules to a control device through connection with the control device of the display wall. The obtaining the plurality of captured images may include obtaining a plurality of images by capturing the display wall while each display module among the plurality of display modules displays the preset image according to control of the control device that receives the control signal. The identifying the location and shape of the display module may include identifying the location and shape of each display module included in the display wall, on the basis of the plurality of images.

A computer-readable medium according to an embodiment may include at least one instruction to cause the electronic device execute an operation including the controlling the display wall to sequentially display a preset image through connection with a display wall including a plurality of display modules by the electronic device, obtaining a plurality of images by controlling the camera to capture the plurality of images of the display wall while each display module among the plurality of display modules displays the preset image, and identifying a location and a shape of each display module among the plurality of display modules of the display wall.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a diagram illustrating a schematic process of identifying each display module by capturing a display wall by an electronic device according to the disclosure;

FIG. 2 is a block diagram illustrating a configuration of an electronic device according to an embodiment of the disclosure;

FIG. 3 is a diagram illustrating an operation of an electronic device for capturing a display wall and a display wall including a plurality of display modules according to an embodiment of the disclosure;

FIG. 4 is a diagram for describing an example in which an electronic device identifies a location and a shape of each of a plurality of display modules by capturing a display wall according to an embodiment of the disclosure;

FIG. 5 is a diagram for describing an example in which an electronic device identifies a form of an entire screen of a display wall according to an embodiment of the disclosure;

FIGS. 6A and 6B are diagrams illustrating other examples of a preset image that may be displayed on each of a plurality of display modules according to an embodiment of the disclosure;

FIGS. 7A and 7B are diagrams for describing an example in which the electronic device performs screen correction on at least one display module based on a map image according to an embodiment of the disclosure;

FIG. 8 is a diagram for describing an example in which the electronic device divides one image into a plurality of sub-images by using a map image according to an embodiment of the disclosure;

FIG. 9 is a block diagram illustrating a detailed configuration of an electronic device according to various embodiments of the disclosure; and

FIG. 10 is a flowchart illustrating a multi display recognition method of an electronic device according to an embodiment of the disclosure.

### DETAILED DESCRIPTION

Before describing the disclosure in detail, a method of describing the present specification and drawings will be described.

The terms used in the present specification and the claims are general terms identified in consideration of the functions of the various embodiments of the disclosure. However, these terms may vary depending on intention, technical interpretation, emergence of new technologies, and the like of those skilled in the related art. Some terms may be selected by an applicant arbitrarily, and the meaning thereof will be described in the detailed description. Unless there is a specific definition of a term, the term may be construed based on the overall contents and technological understanding of those skilled in the related art.

In addition, like reference numerals or signs described in the respective drawings attached to the present specification represent components or components that perform substantially the same functions. For convenience of description and understanding, different embodiments will be described using the same reference numerals or signs. That is, although all the components having the same reference numerals are illustrated in the plurality of drawings, the plurality of drawings do not mean one embodiment.

In addition, in the specification and the claims, terms including ordinal numbers such as “first” and “second” may be used to distinguish the components from each other. Such ordinal numbers are used to distinguish the same or similar elements from each other, and the meaning of the term should not be limited due to the use of the ordinal numbers. For example, a component coupled with such an ordinal number should not be limited in use order or arrangement order by the number. If necessary, the respective ordinal numbers may be replaced with each other.

A singular expression includes a plural expression, unless otherwise specified. It is to be understood that the terms such as “comprise” may, for example, be used to designate a presence of a characteristic, number, step, operation, element, component, or a combination thereof, and not to preclude a presence or a possibility of adding one or more of other characteristics, numbers, steps, operations, elements, components or a combination thereof.

The terms such as “module,” “unit,” “part”, and so on are used to refer to an element that performs at least one function or operation, and such element may be implemented as hardware or software, or a combination of hardware and software. Further, except for when each of a plurality of “modules”, “units”, “parts”, and the like needs to be realized in an individual hardware, the components may be integrated in at least one module or chip and be realized in at least one processor.

Further, in an embodiment of the disclosure, when a portion is referred to as being connected to another portion, it includes not only a direct connection but also an indirect connection through another medium. In addition, the meaning that a part includes a certain element means that another element may be further included instead of excluding other elements unless specifically stated otherwise.

The disclosure provides an electronic device for automatically identifying the location and shape of each of a plurality of display modules included in a display wall, and a multi-display recognition method.

The disclosure provides an electronic device for performing screen correction for a plurality of display modules based on the position and shape of a plurality of display modules included in a display wall, and a multi-display recognition method.

The electronic device and the multi-display recognition method according to the disclosure may automatically identify the location and shape of each display module and perform image quality correction without a user input related to the location and image quality of each display module. That is, when the embodiments according to the disclosure are used, there is an advantage in that the time required for recognizing each display module and the user's effort are reduced.

Since the electronic device and the multi-display recognition method according to the disclosure use a plurality of images captured in a situation in which the display modules sequentially display a preset image, when the types of display modules are different and/or the number of display modules are relatively large, each display module may be recognized without difficulty.

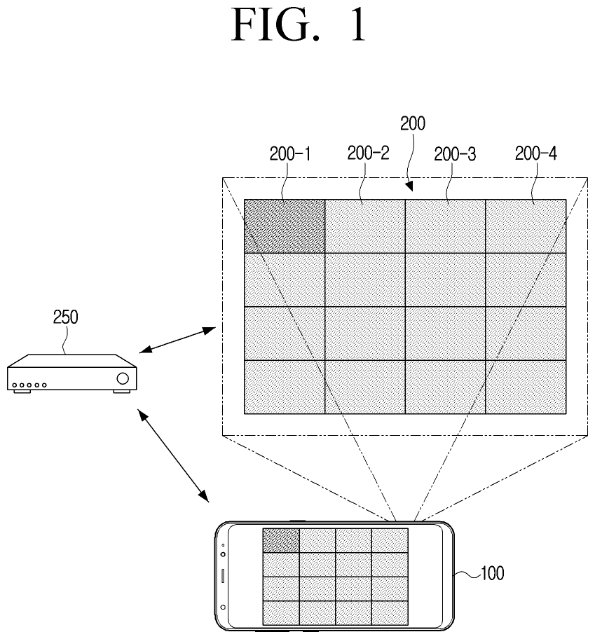

FIG. 1 is a diagram illustrating a schematic process of identifying each display module by capturing a display wall by an electronic device according to the disclosure.

FIG. 1 illustrates that the electronic device 100 implemented with a mobile phone is connected to the display wall 200 through the set-top box 250.

The display wall 200 may include a plurality of display modules 200-1, 2, 3, 4, . . . . As such, the display wall 200 may be implemented as a system including a plurality of display modules each including a display panel.

The electronic device 100 may be connected to the display wall 200 through the set-top box 250 and may control the display wall 200 so that a plurality of display modules 200-1, 2, 3, 4, . . . included in the display wall 200 may sequentially display a preset image.

Referring to FIG. 1, although the electronic device 100 controls the display wall 200 through the set-top box 250, the electronic device 100 may be connected to the display wall 200 without going through the set-top box 250 and the like and may control the display wall 200.

Referring to FIG. 1, the display module 200-1 may display a preset image under the control of the electronic device 100. In this example, the remaining display modules 200-2, 3, 4, . . . may not display a preset image.

While the display module 200-1 displays a preset image, the electronic device 100 may capture the display wall 200 through the camera. The electronic device 100 may capture a plurality of display panels included in a plurality of display modules included in the display wall 200.

The display module 200-2 may display a preset image according to the control of the electronic device 100. The remaining display modules 200-1, 3, 4, . . . may not display a preset image.

While the display module 200-2 displays a preset image, the electronic device 100 may capture the display wall 200 through the camera.

The electronic device 100 may repeat the same process for remaining display modules.

The electronic device 100 may obtain a plurality of captured images by capturing the display wall 200 whenever each display module displays the corresponding image.

The electronic device 100 may use each of the plurality of captured images to determine each location and shape of a plurality of display modules 200-1, 2, 3, 4.

The configurations and operations of the electronic device 100 will be described in greater detail through the drawings.

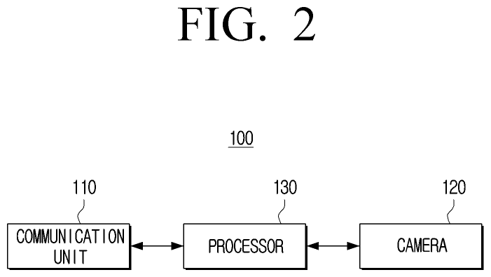

FIG. 2 is a block diagram illustrating a configuration of an electronic device according to an embodiment of the disclosure.

Referring to FIG. 2, the electronic device 100 includes a communication unit 110, a camera 120, and a processor 130. The electronic device 100 may correspond to various terminal devices including the camera 120 while being portable, such as a smart phone, a tablet PC, and a notebook PC.

The communication unit 110 is a configuration for the electronic device 100 to directly/indirectly communicate with various external electronic devices including a display wall to exchange signals/data. The communication unit 110 may include a circuit.

The camera 120 is a configuration to capture at least one image. The camera 120 may include at least one red-green-blue (RGB) image sensor.

The electronic device 100 may use an external camera device instead of the camera 120 of the electronic device 100. In this case, the electronic device 100 may be connected to the camera device to control the camera device. For example, the electronic device 100 implemented as a notebook PC may control the camera device to capture the display wall. The electronic device 100 may receive a plurality of images obtained according to capturing from the camera device. As such, when the electronic device 100 uses an external camera device, there is no problem even if the electronic device 100 does not include the camera 120 itself.

The processor 130 is configured to control each configuration included in the electronic device 100 in overall.

The processor 130 may capture a display wall through the camera 120.

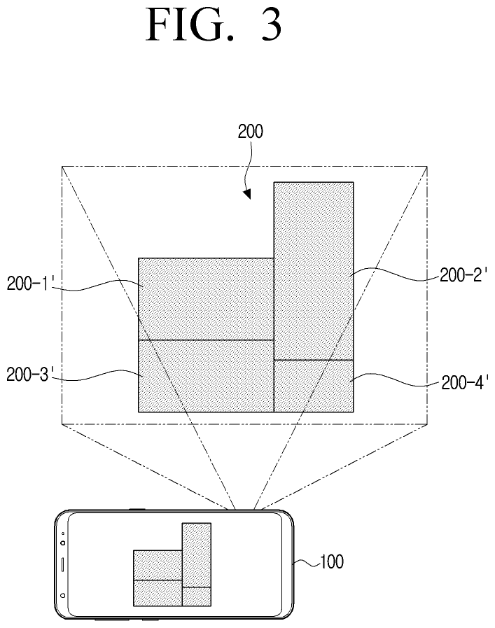

FIG. 3 is a diagram illustrating an operation of an electronic device for capturing a display wall.

FIG. 3, unlike FIG. 1, assumes that the display wall 200 includes a plurality of display modules 200-1′, 2′, 3′, 4′ of different shapes and sizes.

In the disclosure, the shape of the disclosure may refer to various shapes that a display module may have such as a rectangle, a triangle, a polygon, a circle, and the like. The shape may include an aspect ratio when the display module is rectangular. Even in the case of the same quadrangle, if the display modules have different aspect ratios, it is described that the shape is different.

The shape may be a concept including a shape in which a display module is shown. For example, even if the display modules are implemented as squares of the same size, one may be described as being different from each other since the width/length is in the horizontal/vertical direction with respect to the ground while the other is rotated by 45 degrees in the clockwise direction or the counterclockwise direction and is shown as a diamond shape.

In the disclosure, the size may be a concept including the area of the front surface (: panel) of the display module. Also, the size may be a concept including a diagonal length when the shape of the display module is rectangular.

Referring to FIG. 3, the processor 130 may capture the display wall 200 including the display modules 200-1′, 2′, 3′ 4′ through the camera 120.

The processor 130 may capture a screen output by the display panels of the display modules 200-1′, 2′, 3′, 4′.

The processor 130 may control the display wall through the communication unit 110.

In detail, the processor 130 may control the display wall so that the plurality of display modules sequentially display a preset image. Here, the preset images sequentially displayed on the plurality of display modules may be the same image.

The processor 130 may be connected to an external control device (e.g., a set-top box) for controlling a control device included in the display wall or a display wall through the communication unit 110 to control the display wall.

The processor 130 may control the camera 120 to capture the display wall whenever each of the plurality of display modules displays a preset image. The processor 130 may obtain a plurality of captured images through the camera 120.

The preset image is an image for identifying a screen edge of each of the plurality of display modules. The preset image may correspond to various images capable of expressing the shape of each of the plurality of display modules by being displayed on each of the plurality of display modules.

The processor 130 may identify the location and shape of each display module included in the display wall based on the plurality of obtained captured images.

The processor 130 may identify location of each of the plurality of display modules based on the location of the preset image included in each of the plurality of captured images.

The processor 130 may identify the shape of each of the plurality of display modules based on the shape of the preset image included in each of the plurality of captured images.

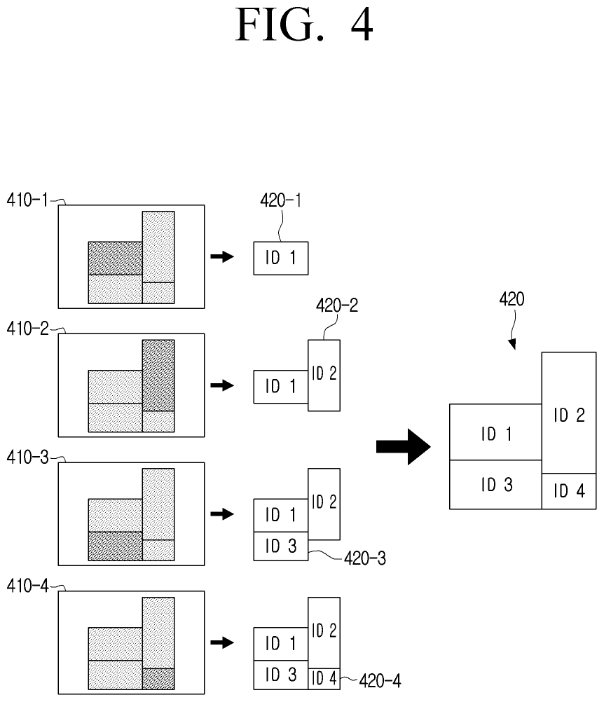

FIG. 4 is a diagram illustrating an example in which the electronic device identifies a location and a shape of each of a plurality of display modules by capturing a display wall. Referring to FIG. 4, the preset image is a color image composed of one color. In addition, the preset image corresponds to an image that fills the entire screen of each module.

Referring to FIG. 4, the processor 130 may control the display wall 200 to sequentially display a preset image by the display modules 200-1′, 2′, 3′, 4′ of FIG. 3.

The processor 130 may sequentially transmit a control signal corresponding to each of a plurality of identification numbers (ex. ID 1, ID 2, ID 3, and ID 4) for distinguishing the plurality of display modules 200-1′, 2′, 3′, and 4′ to the control device of the display wall 200, so that the plurality of display modules 200-1′, 2′, 3′, and 4′ sequentially display a preset image. However, if the plurality of display modules 200-1′, 2′, 3′, and 4′ are not connected to each other to configure one system, but are controlled and operated independently, the processor 130 may sequentially transmit a control signal for each of the plurality of display modules 200-1′, 2′, 3′, and 4′ to each of the plurality of display modules 200-1′, 2′, 3′, and 4′.

Referring to FIG. 4, the processor 130 may control the display wall 200 to display a preset image by the display module 200-1′.

The processor 130 may determine the identification number corresponding to the display module 200-1′ among the plurality of identification numbers to distinguish the display modules 200-1′, 2′, 3′, 4′.

The control signal including information about the determined identification number (e.g., ID 1) may be transmitted to the control device (may be formed inside or outside the display wall 200) of the display wall 200.

The display module 200-1′ may display a preset image under the control of the control device that receives the control signal including the information about the identification number of the display module 200-1′. In this example, the other display modules 200-2′, 3′, and 4′ may not display a preset image.

While displaying the preset image by the display module 200-1′, the processor 130 may capture the display wall 200 through the camera 120. As a result, the processor 130 may obtain a captured image 410-1.

The processor 130 may generate the mapping area 420-1 for the display module 200-1′ based on the size, shape, and location of the preset image included in the captured image 410-1. In this case, the mapping area 420-1 may be stored as a mapping area matching the identification number of the display module 200-1′.

The processor 130 may control the display wall 200 to display a preset image by the display module 200-2′.

The processor 130 may determine an identification number corresponding to the display module 200-2′ and transmit a control signal corresponding to the determined identification number (e.g., ID 2) to the control device of the display wall 200.

While the display module 200-2′ is displaying a preset image, the processor 130 may capture the display wall 200 through the camera 120. As a result, the processor 130 may obtain the captured image 410-2.

The processor 130 may generate a mapping area 420-2 for the display module 200-2′ based on the size, shape, and location of the preset image included in the captured image 410-2.

The processor 130 may identify the relative location relationship among mapping regions 420-1, 2 based on the relative location relationship of the preset image included in each of the captured images 410-1, 2.

Similarly, while the display module 200-3 is displaying a preset image, the processor 130 may capture a captured image 410-3 by capturing the display wall 200 through the camera 120. The processor 130 may generate the mapping area 420-3 for the display module 200-3′ based on the size, shape, and location of the preset image included in the captured image 410-3.

Similarly, based on the captured image 410-4 obtained while the display module 200-4′ is displaying a preset image, the processor 130 may generate the mapping area 420-4 for the display module 200-4′.

The processor 130 may generate the map image 420 for the display wall 200 using the generated mapping areas 420-1, 2, 3, and 4. The processor 130 may store the map image 420 in the memory of the electronic device 100.

The processor 130 may obtain the map image 420 by combining the mapping areas 420-1, 2, 3, 4, using a relative location relationship among the mapping areas 420-1, 2, 3, 4.

The map image 420 may include information about the size and shape of the entire display area of the display wall 200.

The mapping areas 420-1, 2, 3, and 4 corresponding to the plurality of display modules 200-1′, 2′, 3′, and 4′ may be distinguished from each other on the map image 420. The map image 420 may include information about the size, shape, and location of the display area of each of the display modules 200-1′, 2′, 3′, and 4′ included in the display wall 200.

In the case of FIG. 4, as a result of combination of the mapping areas 420-1, 2, 3, and 4 of each of the display modules, the entire contour of the map image 420 (corresponding to the size and shape of the entire display area of the display wall 200) of the display wall 200 is defined, but the processor 130 may first define the entire contour of the map image 420 before generating the mapping area of each of the display modules.

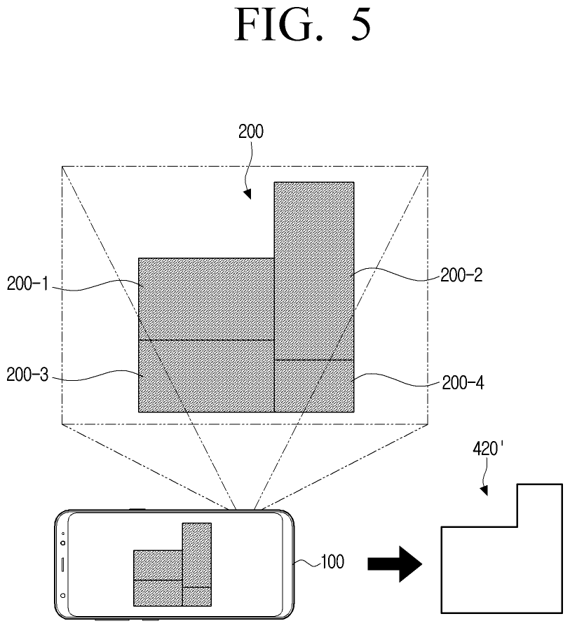

FIG. 5 is a diagram for describing an example in which an electronic device identifies a form of an entire screen of a display wall.

Referring to FIG. 5, the processor 130 may control the display wall 200 such that the plurality of display modules 200-1′, 2′, 3′, and 4′ simultaneously display a preset image. In this example, the processor 130 may obtain one captured image by capturing the display wall 200 and define the entire contour 420′ of the map image 420 with respect to the display wall 200 based on the captured image.

The processor 130 may identify each mapping region 420-1, 2, 3, 4 included in the map image 420 through the process of FIG. 4.

As a result of using the plurality of images sequentially obtained while the display modules included in the display wall are sequentially displaying the preset image, the electronic device 100 according to the disclosure may automatically identify the location and shape of each of the plurality of display modules included in the display wall.

In particular, even when information about the size and shape of the display wall and the size and shape of each display module are pre-stored or not input, the electronic device 100 according to the disclosure may determine the size, location, and shape of each display module.

The electronic device 100 according to the disclosure has an advantage in that the electronic device 100 does not require the user's operation of identifying and inputting the location of each display module or capturing each display module.

Unlike the above-described embodiments, the electronic device 100 may control the plurality of display modules to simultaneously display different preset images.

For example, the processor 130 may identify each module based on images of different colors output from each of the plurality of display modules (e.g., a red image, a module 2: a blue image, a module 3: a brown image, etc.). At this time, the display module displaying the red image may be determined as “module 1”.

However, in a state an image attribute or image property of a screen actually output by each display module may not be defined/corrected, a problem may occur.

For example, if before performing the screen correction for the display wall, even if the display modules output red image/blue image/brown image through the control of the electronic device, the actually output red image/blue image/brown image may be distorted little by little compared to the information previously stored in the electronic device. The output images may not be accurately recognized as red image/blue image/brown image by the electronic device.

In the embodiments of the disclosure described above with reference to the drawings described above, there is no problem in that time intervals in which a plurality of display modules display a preset image are clearly distinguished.

In particular, even before screen correction is performed, there is no problem for the electronic device 100 in recognizing each display module, since it is sufficient that the remaining display modules do not display any image or collectively display another image completely distinguished from a preset image during a time interval in which one display module displays a preset image.

The preset image may be various images other than a color image (e.g., FIG. 4) that fills the entire screen of each display module.

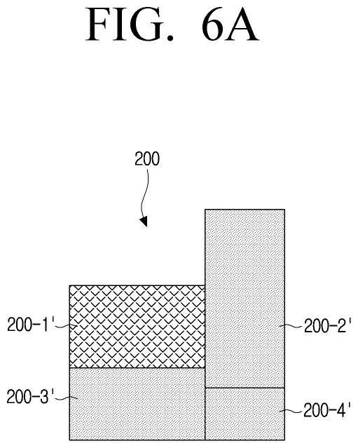

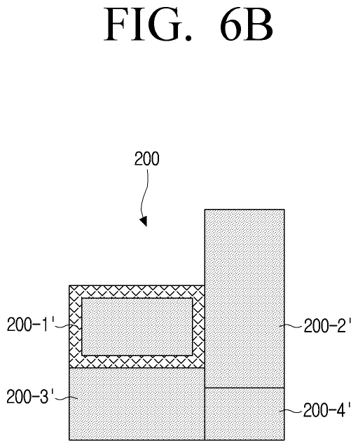

FIGS. 6A and 6B are diagrams illustrating other examples of a preset image that may be displayed on each of a plurality of display modules.

For example, as displayed by the display module 200-1′ in FIG. 6A, the preset image may be a pattern image that fills the entire screen of each display module.

As an example, as the display module 200-1′ displays in FIG. 6B, the preset image may be an image in which an area within a predetermined range from the screen edge of each display module is composed of a specific color/pattern.

Various images for identifying a screen edge of each display module may be used as “a preset image”.

The electronic device 100 may control the display wall so that the plurality of display modules are sequentially turned off. In this case, whenever each display module is turned off, the remaining display modules may display a preset image.

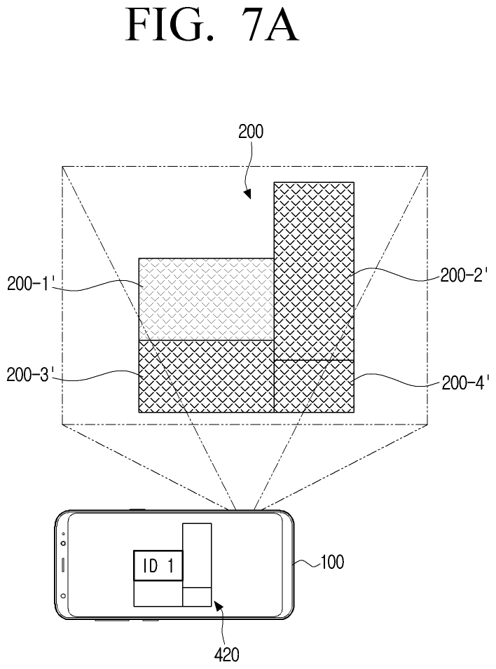

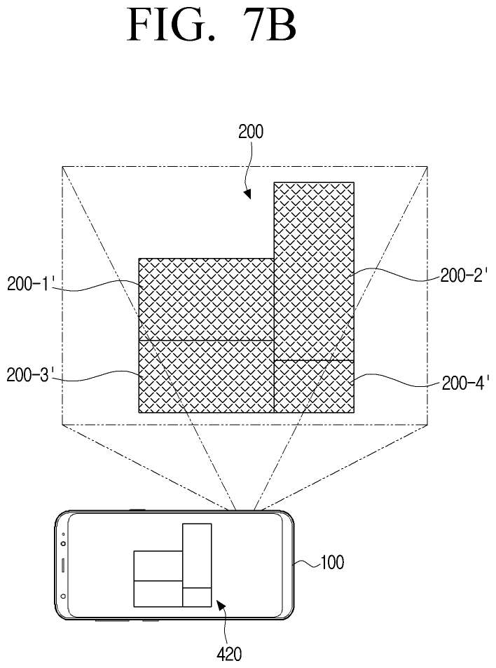

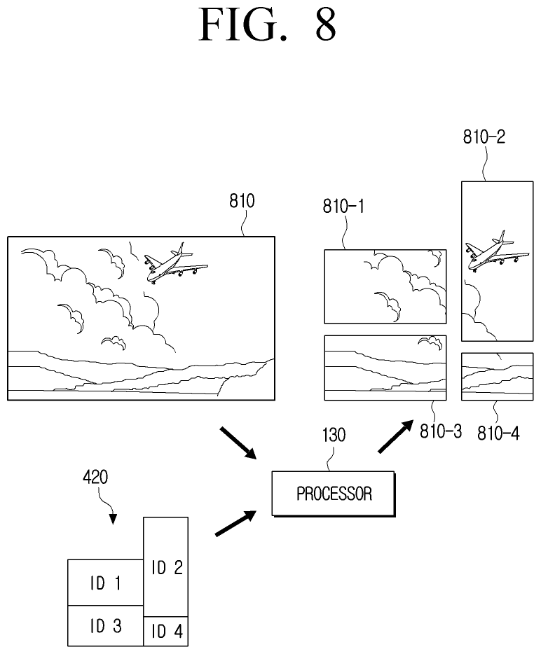

When a map image in which a plurality of display modules are divided is generated as shown in FIG. 4, the processor 130 may perform various operations using the generated map image. Hereinafter, a description will be given with reference to FIGS. 7A to 7B and 8.

FIGS. 7A and 7B are diagrams for describing an example in which the electronic device performs screen correction on at least one display module based on a map image.

Referring to FIG. 7A, the processor 130 may control the display wall 200 through the communicator 110 such that at least one of the plurality of display modules 200-1′, 2′, 3′, and 4′ displays a test image.

At this time, the plurality of display modules 200-1′, 2′, 3′, and 4′ may sequentially display the test images or simultaneously display the test images as shown in FIG. 7A. FIG. 7A illustrates a situation in which all of a plurality of display modules 200-1′, 2′, 3′, and 4′ display a test image.

The processor 130 may obtain the captured image by capturing the display wall 200 through the camera 120.

Based on the obtained captured image, the processor 130 may identify a region requiring screen correction on the map image 420.

The processor 130 may identify a region in which chroma, sharpness, color sense, etc., of the entire region in which the test image is output deviates from a preset range. Alternatively, the processor 130 may identify at least one region in which chroma, sharpness, color sense, etc. are different from the remaining region among the entire region in which the test image is output. Various image attributes may be used in addition to the chroma, sharpness, and color sense.

Referring to FIG. 7A, in the example of the test image displayed by the display module 200-1′, chroma is higher than the test image displayed by other display modules 200-2′, 3′, 4′.

In this example, the processor 130 may identify the display module 200-1′, ID 1 corresponding to the area having high chroma among the entire region in which the test image is output.

The processor 130 may determine a mapping area including an area having a high chroma among mapping areas mapped to each of the plurality of display modules 200-1′, 2′, 3′, and 4′, and identify the display module 200-1′ corresponding to the determined mapping area.

The processor 130 may perform screen correction regarding the identified display module 200-1′.

The processor 130 may determine a correction value for at least one image attribute. For example, when it is determined that the chroma of the display module 200-1′ is 2 level higher than the preset reference chroma, the processor 130 may determine that the correction value for the chroma of the display module 200-1′ is “−2” level.

The processor 130 may transmit the determined correction value to the display wall or the control device of the display wall. As a result, the image attribute (e.g., chroma) of the display module 200-1′ may be corrected.

The screen correction may include correction for various image attributes such as color correction, sharpness correction, and the like, in addition to the above-described chroma correction. As a specific example, various corrections such as local uniformity correction, white balance correction, and gamma correction for enhancing sharpness may be possible.

After screen correction for the display module 200-1′ is performed, the processor 130 may again capture the display wall 200 displaying the test image. If necessary, the processor 130 may perform additional screen correction on at least one display module.

As a result of the screen correction, as shown in FIG. 7B, all of the plurality of display modules 200-1′, 2′, 3′, and 4′ included in the plurality of display walls 200 may display a test image having the same chroma.

The above-described embodiment of identifying the location and shape of each of the plurality of display modules and performing screen correction on the plurality of display modules based on the identified location and shape may be advantageous in that when the display wall includes a relatively large number of display modules and/or if the size/shape/location of the display modules is irregular, screen correction may be performed without problems.

Since the above-described embodiment does not require a separate user input unlike the related art, it is advantageous that the time required for identifying each display module and performing the screen correction is reduced and convenience is increased.

FIG. 8 is a diagram for describing an example in which the electronic device divides one image into a plurality of sub-images by using a map image. FIG. 8 has a premise that the electronic device 100 displays an image 810 using the display wall 200.

Referring to FIG. 8, the processor 130 may divide the image 810 into a plurality of sub-images 810-1, 2, 3, 4 corresponding to each of the plurality of display modules 200-1′, 2′, 3′ 4′.

As an example, the processor 130 may extract one region that matches the shape of the map image 420 (the entire contour) in the image 810. The processor 130 may obtain a plurality of sub-images 810-1, 2, 3, and 4 by dividing the extracted areas as the mapping areas in the map image 420 are divided.

For example, the processor 130 may enlarge or reduce the image 810 based on the size of the map image 420, and then extract one region matching the shape of the map image 420 in the enlarged or reduced image. The processor 130 may obtain the plurality of sub-images 810-1, 2, 3, and 4 by dividing the extracted region as the mapping regions in the map image 420 are divided.

As an example, the processor 130 may enlarge or reduce the map image 420 based on the size of the image 810. The processor 130 may extract one region matching the shape of the enlarged or reduced map image in the image 810. The processor 130 may obtain a plurality of sub-images 810-1, 2, 3, and 4 by dividing the extracted region such that mapping regions in the enlarged or reduced map image are divided.

The processor 130 may transmit a plurality of sub-images 810-1, 2, 3, 4 to the display wall 200 through the communication unit 110.

As a result, the display wall 200 may display the image 810. Specifically, the display module 200-1′ may display the sub image 810-1, the display module 200-2′ may display the sub image 810-2, the display module 200-3′ may display the sub image 810-3, and the display module 200-4′ may display the sub image 810-4.3333-15-4439706

The processor 130 may transmit information on the map image to the display wall or the control device of the display wall through the communication unit 110. In this case, depending on the location, shape, and size of the plurality of display modules identified through the map image, at least one image may be displayed on the display wall.

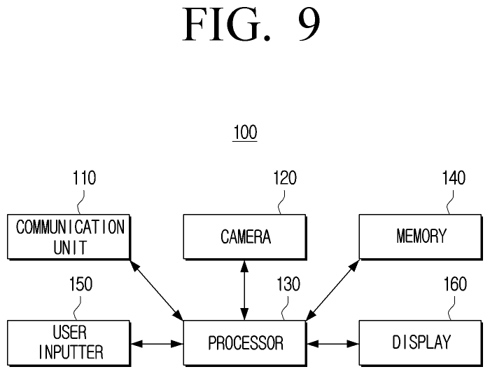

FIG. 9 is a block diagram illustrating a detailed configuration of an electronic device according to various embodiments of the disclosure.

Referring to FIG. 9, the electronic device 100 may further include a memory 140, a user inputter 150, a display 160, or the like, in addition to the communication unit 110, camera 120, and processor 130.

The communication unit 110 may be connected to an external electronic device based on a network implemented through wired communication and/or wireless communication. The communication unit 110 may be directly connected to an external electronic device, but may be connected to an external electronic device through one or more external servers (e.g., Internet Service Provider (ISP)) that provides a network.

The network may be a personal area network (PAN), a local area network (LAN), a wide area network (WAN), or the like depending on the area or size, and may be an Intranet, an Extranet, or the Internet according to the openness in the network.

The wireless communication, for example, may include at least one of the communication methods such as long-term evolution (LTE), LTE advanced (LTE-A), 5th generation (5G), a code division multiple access (CDMA), a wideband CDMA (WCDMA), and a universal mobile telecommunications system (UMTS), a wireless broadband (WiBro), or a global system for mobile communications (GSM), time division multiple access (DMA), Wi-Fi, WiFi Direct, Bluetooth, near field communication (NFC), Zigbee, or the like.

Wired communication may include at least one of the communication methods such as Ethernet, optical network, universal serial bus (USB), ThunderBolt, or the like.

The communication unit 110 may include a network interface or a network chip according to the wired/wireless communication method described above. The communication method is not limited to the above-described example, and may include a communication method newly appearing according to the development of technology.

The processor 130 may include a general purpose processor, such as a central processing unit (CPU), an application processor (AP), or the like, a graphics-only processing unit such as a graphics processing unit (GPU), a visual processing unit (VPU), or an AI-dedicated processor such as a neural processing unit (NPU). The processor 130 may include a volatile memory such as SRAM.

The memory 140 is configured to store an operating system (OS) for controlling the overall operation of the components of the electronic device 100 and at least one instruction or data related to the components of the electronic device 100. The processor 130 may perform an operation according to various embodiments to be described below by executing at least one instruction stored in the memory 140.

The memory 140 may include a non-volatile memory such as read only memory (ROM), flash memory, or the like, and may include volatile memory composed of DRAM, etc. The memory 140 may include a storage composed of a hard disk, solid state drive (SSD), or the like.

The memory 140 may store information (e.g., identification number) for identifying a plurality of display modules included in the display wall. A map image in which a plurality of display modules are divided may be stored in the memory 140.

The user inputter 150 is configured to receive at least one user command.

For example, when an application for screen correction of the display wall is executed on the electronic device 100, if a user command for requesting the start of the screen correction is input through the user inputter 150, the operation of the electronic device 100 according to the above-described embodiments may be performed through FIGS. 2 to 8.

The user inputter 150 may include one or more buttons, a keyboard, a mouse, and the like. In addition, the user inputter 150 may include a touch panel implemented together with a display or a separate touch pad.

The user inputter 150 may include a microphone to receive a user command or input data as a voice, and may include a camera for receiving a user command or input data in an image or motion form.

The processor 130 may display an execution screen of an application for screen correction of the display wall through the display 160.

In the process of FIGS. 3 to 5, the processor 130 may control the display 160 to display at least one captured image for a display wall displaying a preset image.

In the processes of FIGS. 7A and 7B, the processor 130 may control the display 160 to display at least one captured image for the display wall displaying the test image.

The display 160 may be implemented as, for example, a liquid crystal display (LCD), plasma display panel (PDP), organic light emitting diodes (OLED), transparent OLED (TOLED), micro LED, or the like.

The display 160 may be implemented in the form of a touch screen capable of sensing a user's touch manipulation, and may be implemented as a flexible display that may be folded or bent.

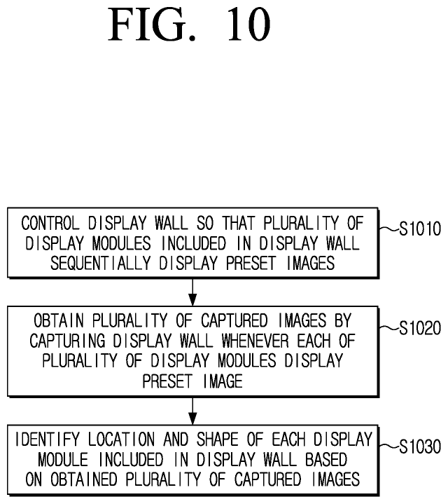

Through FIG. 10, a multi-display recognition method of an electronic device according to the disclosure will be described through FIG. 10.

FIG. 10 is a flowchart illustrating a multi display recognition method of an electronic device according to an embodiment of the disclosure.

Referring to FIG. 10, a method for recognizing a multi-display of an electronic device includes controlling a display wall so that the plurality of display modules sequentially display a preset image through connection with the display wall including a plurality of display modules in operation S1010. As a specific example, a control signal corresponding to each of a plurality of identification numbers for distinguishing a plurality of display modules may be sequentially transmitted to the control device by being connected to the control device of the display wall.

The display wall may be controlled so that the plurality of display modules display the preset image for identifying a screen edge of each of the plurality of display modules. The display wall may be controlled so that each of the plurality of display modules displays the same preset image.

The preset image may be a pattern image or a color image that fills an entire screen of each of the plurality of display modules, but is not limited thereto.

The method for recognizing a multi-display of an electronic device includes obtaining a plurality of captured images by capturing the display wall whenever each of the plurality of display modules displays the preset image in operation S1020. To be specific, by capturing the display wall whenever the plurality of display modules displays a preset image according to the control of a control device receiving a control signal, the plurality of captured images may be obtained.

The multi-display recognition method may identify the location and shape of each display module included in the display wall based on the obtained plurality of captured images in operation S1030. As a specific example, based on the obtained plurality of captured images, the location and shape of each display module corresponding to each of the plurality of identification numbers may be identified.

At this time, the location of each of the plurality of display modules may be identified based on a location of a preset image included in each of the plurality of captured images. In addition, the shape of each of the plurality of display modules may be identified based on a shape of a predetermined image included in each of the plurality of captured images.

The method may further include, based on the identified location and shape of each display module, generating one map image in which the plurality of display modules are divided in the display wall.

The map image may be provided to the display wall.

By using a map image, screen correction for the display wall may be performed.

The method may include obtaining a captured image by capturing the display wall through the camera while at least one of the plurality of display modules is displaying a test image. In this example, a region that requires screen correction in the captured image may be identified, and a display module of a location corresponding to the identified region in the map image may be identified. The screen correction for the identified display module may be performed.

The method may further include, dividing, based on the map image, an image displayed on the display wall into a plurality of sub-images corresponding to each of the plurality of display modules; and transmitting the plurality of sub-images to the display wall.

The multi-display recognition method described above may be performed through the electronic device 100 described with reference to FIGS. 2 and 11. In addition, the above-described multi-display recognition method may be performed through a system including the electronic device 100 and at least one external device (e.g., server, etc.).

Various exemplary embodiments described above may be embodied in a recording medium that may be read by a computer or a similar apparatus to the computer by using software, hardware, or a combination thereof.

By hardware implementation, the embodiments of the disclosure may be implemented using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, or electric units for performing other functions.

In some cases, embodiments described herein may be implemented by the processor 130 itself. According to a software implementation, embodiments, such as the procedures and functions described herein, may be implemented with separate software modules. Each of the above-described software modules may perform one or more of the functions and operations described herein.

According to various embodiments described above, computer instructions for performing processing operations of the electronic device 100 according to the various embodiments described above may be stored in a non-transitory computer-readable medium. The computer instructions stored in the non-transitory computer-readable medium may cause a particular device to perform processing operations on the electronic device 100 according to the various embodiments described above when executed by the processor of the particular device.

A non-transitory computer-readable medium refers to a medium that stores data semi-permanently, rather than a medium that stores data for a short moment, such as a register, cache, memory, etc., and refers to a medium readable by a device. Specifically, the programs for performing the various methods described above may be stored and provided in a non-transitory readable medium, such as a compact disc (CD), a digital video disc (DVD), a hard disk, a Blu-ray disc, a universal serial bus (USB), a memory card, a read-only memory (ROM), etc.

While the disclosure has been shown and described with reference to various example embodiments thereof, it will be understood by those skilled in the art that various changes in form and details may be made therein without departing from the spirit and scope of the disclosure as defined by the appended claims and their equivalents.

What is claimed is:

1. An electronic device comprising:
a communication unit;
a camera; and
a processor configured to control, through the communication unit, a display wall comprising a plurality of display modules, and
wherein the processor is further configured to:
control the display wall so that the plurality of display modules sequentially display a preset image,
obtain a plurality of images by controlling the camera to capture the plurality of images of the display wall while each display module among the plurality of display modules displays the preset image, and
identify a location and a shape of each display module among the plurality of display modules of the display wall, based on the plurality of images.

2. The electronic device of claim 1, wherein the preset image identifies a screen edge of each display module among the plurality of display modules, and
wherein the processor is further configured to:
identify the location of each display module among the plurality of display modules based on a location of the preset image included in each image among the plurality of images, and
identify the shape of each display module among the plurality of display modules based on a shape of the preset image included in each image among the plurality of images.

3. The electronic device of claim 2, wherein the preset image is a pattern image or a color image that fills an entire screen of each display module among the plurality of display modules, and
wherein the processor is further configured to control the display wall so that each display module among the plurality of display modules displays the preset image.

4. The electronic device of claim 1, further comprising:
a memory,
wherein the processor is further configured to, based on the identified location and shape of each display module, generate a map image in which the plurality of display modules are divided in the display wall and control the memory to store the map image.

5. The electronic device of claim 4, wherein the processor is further configured to provide the map image stored in the memory to the display wall through the communication unit.

6. The electronic device of claim 4, wherein the processor is further configured to:
obtain a captured image of the display wall captured through the camera while at least one of the plurality of display modules is displaying a test image,
identify a region that requires screen correction in the captured image,
identify a display module corresponding to a location of the identified region in the map image, and
perform the screen correction for the identified display module.

7. The electronic device of claim 4, wherein the processor is further configured to:
divide, based on the map image, an image to be displayed on the display wall into a plurality of sub-images corresponding to each display module among the plurality of display modules, and
transmit the plurality of sub-images to the display wall through the communication unit.

8. The electronic device of claim 1, wherein the processor is further configured to:
sequentially transmit a control signal corresponding to each identification number among a plurality of identification numbers distinguishing the plurality of display modules to a control device by being connected to the control device of the display wall through the communication unit,
obtain the plurality of images by controlling the camera to capture the display wall while each display module among the plurality of display modules displays the preset image according to control of the control device that receives the control signal, and
identify the location and the shape of each display module corresponding to each of the plurality of identification numbers based on the plurality of images.

9. A method for recognizing a multi-display of an electronic device, the method comprising:
controlling a display wall so that a plurality of display modules sequentially display a preset image through connection with the display wall including the plurality of display modules;
obtaining a plurality of images by capturing the plurality of images of the display wall while each display module among the plurality of display modules displays the preset image; and
identifying a location and a shape of each display module among the plurality of display modules of the display wall, based on the plurality of images.

10. The method of claim 9, wherein the controlling the display wall comprises controlling the display wall so that the plurality of display modules display the preset image which identifies a screen edge of each of the plurality of display modules,
wherein the identifying the location and shape of each display module comprises:
identifying the location of each display module among the plurality of display modules based on a location of the preset image included in each image among the plurality of images, and
identifying the shape of each display module among the plurality of display modules based on a shape of the preset image included in each image among the plurality of images.

11. The method of claim 10, wherein the preset image is a pattern image or a color image that fills an entire screen of each display module among the plurality of display modules,
wherein the controlling the display wall comprises controlling the display wall so that each display module among the plurality of display modules displays the preset image.

12. The method of claim 9, further comprising:
based on the identified location and shape of each display module, generating a map image in which the plurality of display modules are divided in the display wall.

13. The method of claim 12, further comprising:
providing the map image to the display wall.

14. The method of claim 12, comprising:
obtaining a captured image of the display wall through a camera while at least one of the plurality of display modules is displaying a test image;
identifying a region that requires screen correction in the captured image;
identifying a display module corresponding to a location of the identified region in the map image; and
performing the screen correction for the identified display module.

15. The method of claim 12, further comprising:
dividing, based on the map image, an image to be displayed on the display wall into a plurality of sub-images corresponding to each display module among the plurality of display modules; and
transmitting the plurality of sub-images to the display wall.
